(19) United States
(12) Patent Application Publication
(10) Pub. No.: US 2024/0009847 A1
(43) Pub. Date: Jan. 11, 2024

(54) POWER TOOL SYSTEM AND METHOD FOR CONTROLLING A MOBILE POWER TOOL

(71) Applicant: Hilti Aktiengesellschaft, Schaan (LI)

(72) Inventors: Sasha LUKIC, Buchs (CH); Peter BRUGGER, Feldkirch (AT); Julia ZANONA, Feldkirch (AT); Eirik STRAND, Sogndal (NO)

(21) Appl. No.: 18/035,703

(22) PCT Filed: Oct. 20, 2021
(86) PCT No.: PCT/EP2021/079031

§ 371 Date: May 5, 2023

(30) Foreign Application Priority Data
Dec. 17, 2020 (EP) 20214917.5

(51) Int. Cl. B25J 9/16; B25J 11/00

(52) U.S. Cl. CPC B25J 9/1687; B25J 9/162; B25J 11/005; B25J 9/1697

(57) ABSTRACT

A power tool system for a construction site is described, comprising a mobile power tool, the mobile power tool being set up for working, at at least one working position on the construction site, a control unit for controlling the mobile power tool, comprising a microprocessor unit and a program-code storage unit, in which program code that can be executed on the microprocessor unit can be stored, and also a structural-part data storage unit, in which at least one structural-part data record relating to at least one structural part to be used on the construction site can be stored, the control unit being set up to determine the working position on the basis of a structural-part data record stored in the structural-part data storage unit. A for controlling a mobile power tool is also provided.

The invention is based on a power tool system for a construction site, comprising a mobile power tool, the mobile power tool being set up for working, in particular with a tool, at at least one working position on the construction site.

In the past there have been recurrent instances of serious accidents being caused by structural parts that are improperly fitted on a construction site. In addition, the lifetime of a structure can be reduced significantly by improperly fitted structural parts.

The object of the present invention is therefore to provide a power tool system for a construction site with a mobile power tool and also a method for controlling a mobile power tool on a construction site that make it possible for work to be safely performed on the construction site in a sustainable manner.

The object is achieved by a power tool system for a construction site, comprising a mobile power tool, the mobile power tool being set up for working, in particular with a tool, at at least one working position on the construction site, a control unit for controlling the mobile power tool, comprising a microprocessor unit and a program-code storage unit, in which program code that can be executed on the microprocessor unit can be stored, and also a structural-part data storage unit, in which at least one structural-part data record relating to at least one structural part to be used on the construction site can be stored, the control unit being set up to determine the working position on the basis of a structural-part data record stored in the structural-part data storage unit.

A concept underlying the invention is therefore that of determining the working position on the basis of the stored structural-part data record. Such a determination of the working position may be understood as meaning in particular an active ascertainment of the working position, for example a calculation of the working position or at least an active verification that a predetermined position value is suitable as a working position to be determined, in particular in contrast to a preselection, for example by a user of the power tool system. It is therefore no longer necessary that the user of the power tool system sets and/or preselects the working position. This makes it possible to make the working position match the structural-part data record. If the structural-part data record comprises for example a safety instruction that the working position must at least maintain a certain distance from a periphery of the structural part, this can be taken into account in the determination of the working position. This may be taken into account automatically by the power tool system, in particular by the control unit. It can consequently be ensured in a surprisingly easy way that one or more requirements, in particular safety requirements, for the structural part are satisfied when performing the work. The risk of improper fitting of the structural part, and accompanying later endangerment of persons or objects, can consequently be considerably reduced or even eliminated completely.

The mobile power tool may be a construction robot. The mobile power tool, in particular the construction robot, may preferably be set up for use in building construction and/or civil engineering. It may in particular not be suitable for use in mining.

The tool may be a drilling tool, a chiseling tool, a cutting tool, a sawing tool, a setting tool, for example for setting a connecting element, for example a screw or a nail, a grinding tool or a marking tool, for example comprising a spray nozzle, and/or comprise such a tool.

The structural part to be used may be a wall, a ceiling or a floor on the construction site, for example of a structure to be erected. The structural part may also be a structural element. For example, the structural part may be a ceiling element, a wall element, an installation element, a connecting element, for example a screw anchor, or the like.

The control unit may form part of the mobile power tool. It may also be formed separately from the mobile power tool, in particular separately from the rest of the control unit. At least part of the control unit may be of a portable design.

The structural-part data record may comprise a type of structural part, for example the type of a ceiling element, a material, for example steel or concrete, and/or an indication of size, for example a dimension. It is conceivable that the structural-part data record comprises an indication of size in relation to a relative working position within the type of structural part concerned.

In a further configuration of the invention, the control unit may be set up to determine the working position by using a construction-site data record of a construction-site data storage unit. For this purpose, the control unit may comprise a construction-site data storage unit, in which at least one construction-site data record can be stored. The construction-site data record may correspond to an actual value or a target value. For example, the construction-site data record may originate from Building Information Model (BIM) planning.

While the structural-part data record may consequently comprise an indication with respect to the structural part, the construction-site data record may comprise an indication with respect to the construction site.

Consequently, safety requirements that arise from the interaction of the structural part with the construction site can be taken into account in the determination of the working position.

For example, one requirement may be that the structural part, for example a supporting element, may only be fitted at a certain minimum distance from a periphery of a wall. Then, the construction-site data record may comprise an indication of size in relation to the wall, for example in relation to the position and/or the location of the wall, in particular its peripheries. The structural-part data record may comprise an indication of the type of structural part, here therefore the type of supporting element. A further structural-part data record may comprise an indication in relation to a relative position and a relative location of a borehole in the supporting element in relation to a corner point of the supporting element. Consequently, a working position, in particular a drilling position within the wall, can be determined on the basis of the structural-part data records in combination with the construction-site data record by suitable summation, so that the requirement with respect to the minimum distance is met.

The control unit may also be set up to determine the working position by using a rule data record of a rule-data storage unit. For this purpose, the control unit may comprise a rule-data storage unit, in which at least one rule data record can be stored. The rule data record may comprise rules in relation to the relative relationship between at least two structural parts and/or in relation to the relative relationship between at least one structural part and the construction site. For example, the rule data record may comprise a rule in relation to the planar arrangement of the structural part or parts within the construction site. The rule data record may also comprise an indication in relation to a safety requirement, for example in relation to the previously mentioned requirement. Such a rule data record makes it possible in a particularly easy way for the power tool system, in particular the control unit, to be set up to determine a number of working positions, for example of different structural parts, according to a rule taking the form of a rule data record. It is consequently possible for the power tool system to take into account not only safety requirements but also other requirements, such as for example esthetic requirements or the like, in the determination of at least one working position.

The control unit may be set up to determine the working position by modifying a predefined target working position, in particular by using the structural-part data record, the construction-site data record and/or the rule data record. It is conceivable in particular that the working position is already predefined in the form of the target working position. For example, the target working position may originate from a BIM planning system.

The power tool system, in particular the control unit, may be set up to adjust the target working position with the structural-part data record and/or with the construction-site data record. It may in particular be set up to ascertain whether all of the requirements relevant to the working position to be determined, including the rules of the rule data record, can be satisfied and/or are satisfied at the same time.

If all of the requirements are already satisfied, the target working position can be adopted unchanged by the power tool system, in particular by the control unit, as the working position to be determined.

If different requirements are in a mutual, unresolvable conflict, the power tool system, in particular the control unit, may be set up to run automatically through a conflict-resolving process and/or to request interaction on the part of the user of the power tool system.

If the target working position is in conflict with one or more of the requirements, the power tool system, in particular the control unit, may be set up to determine an offset, so that when the target working position is displaced by the offset, all of the requirements are satisfied. In particular in the usual case where different offsets are possible, the power tool system, in particular the control unit, may be set up to ascertain among all of the possible offsets the offset with the smallest possible offsetting distance. As an alternative or in addition, it is conceivable for this case that the power tool system, in particular the control unit, is set up to ask for a corresponding selection of an offset by a user.

The working position to be determined can consequently have been determined or be determined by modification of the target working position, in particular so as to correspond to the position that is obtained after displacing the target working position by the offset ascertained.

In the case of a particularly advantageous class of embodiment of the invention, the control unit has a recording sensor for recording at least one structural-part data record and/or a construction-site data record.

In particular, the recording sensor may comprise an image-recording unit, for example an optical camera, for recording a one-dimensional, two-dimensional and/or three-dimensional image. As an alternative or in addition, the recording sensor may comprise a distance meter. The distance meter may be a laser distance meter. The recording sensor may be arranged on the control unit and/or on the mobile power tool. Alternatively, it may also be arranged independently of the control unit and/or independently of the mobile power tool, in particular on the construction site.

The recording sensor may be set up to automatically ascertain the structural-part data record and/or the construction-site data record.

For this purpose, the control unit may comprise an analysis unit for the analysis of the image.

Consequently, the control unit may be set up to detect the structural part and/or to ascertain a position, a location and/or a dimension of the structural part within the construction site. The control unit may also be set up to detect the construction site and/or to detect a position, a location and/or a dimension within the construction site. For example, the power tool system, in particular the control unit, and preferably by using the recording sensor, may be set up to ascertain at least one dimension of a space, a wall, a ceiling and/or a floor located on the construction site.

Preferably, the analysis unit is of a self-learning design. For this purpose, it may comprise an artificial neural network, for example in the form of a deep-learning unit.

The power tool system according to the invention can be used particularly in the case of frequently recurring work.

It is therefore favorable if the mobile power tool is set up for drilling, hammer-drilling and/or chiseling.

It is particularly advantageous here that a power tool system according to the invention, set up for example for drilling and/or hammer-drilling, makes forward-looking implementation of work possible. In particular, the power tool system may be set up, for example by means of suitable rule data records, to detect that one of the target working positions of boreholes is to be modified, and that for this purpose all of the boreholes that are associated with this target working position must be correspondingly changed, so that the outcome is that structural parts can be fitted properly and consistently in spite of the modification of the target working positions.

For example, the power tool system may detect with respect to a first ceiling element that the first ceiling element is in reality to be offset with respect to a position defined in BIM planning, since the ceiling on which the ceiling element is to be fitted is likewise in reality located at a changed position with respect to the BIM planning. Then, the power tool system according to the invention may be set up to additionally also offset correspondingly all other ceiling elements to be fitted on the ceiling or boreholes required for fitting the ceiling elements, so that the outcome is that, although the ceiling elements are offset with respect to the BIM planning, they can be fitted on the ceiling consistently and in accordance with all requirements without any further remedial work.

As a result, operation of the power tool system that is automated to the highest possible degree is also made possible.

In the case of previously known systems, by contrast, there was the problem that fitting problems arising because of unsuitably set boreholes sometimes could not be detected until a much later time and led to considerable dismantling and remedial work. Consequently, such interruptions and necessary manual interventions restricted the previously achievable degree of automation of construction robots.

It is also conceivable that the mobile power tool is set up to select the tool to be used for performing the work from a set of tools. For this purpose, the mobile power tool may be equipped with a tool changing system. It may also have a tool tray for depositing one or more tools.

Particularly preferably, the mobile power tool may be set up to select the tool to be used for performing the work on the basis of the structural-part data record and/or on the basis of the construction-site data record. Consequently, the mobile power tool may for example be set up to select from a set of drilling tools of different sizes a drilling tool of a suitable size in dependence on a structural-part data record in which a diameter of a borehole to be introduced into the structural part is stored.

A particularly wide application area is obtained for the power tool system if at least one element of the power tool system, in particular the mobile power tool or the control unit or at least part of the control unit, can be operated without a cable. It may for this purpose have at least one rechargeable storage battery, for example a lithium-based storage battery, and/or a fuel cell.

For communication with a user, the control unit may have a display unit. The display unit may be set up for indicating the working position.

For safety reasons, the control unit may be set up to start the work of the mobile power tool only after a positive acknowledgement on the part of a user.

In the case of a particularly user-friendly embodiment of the invention, the control unit may have a display unit, in particular for showing an Augmented Reality (AR) image. The AR image may take the form of a Mixed Reality (MR) image or the form of a Virtual Reality (VR) image. In particular, the control unit may be set up to depict the determined working position and/or a comparison between the target working position and the working position.

At least one element of the control unit may be of a cloud-based design. The at least one element may be able to be used with the rest of the power tool system by way of a network, for example a cellular-based network or generally the Internet, and/or be able to be connected or be connected to the rest of the power tool system.

At least two of the storage units may be formed by means of at least one commonly used electronic component. In particular, two or more of the storage units may be formed by means of the same memory components.

It is conceivable in particular that the structural-part data storage unit or at least part of the structural-part data storage unit is formed in one or more remote, in particular cloud-based, storage systems. Thus it is conceivable that the structural-part data storage unit is formed as part of one or more structural-part databases or at least partly by the one or more structural-part databases of one or more manufacturers of structural parts.

The scope of the invention also covers a method for controlling a mobile power tool, in particular a construction robot, preferably for use in building construction and/or civil engineering, on a construction site, the mobile power tool being set up for working, in particular with a tool, at at least one working position on the construction site, the working position being determined on the basis of a structural-part data record.

By analogy with the power tool system according to the invention, the method according to the invention therefore also allows that the working position is determined automatically instead of having to be preset by a user of the method or of the mobile power tool.

Consequently, according to the method, in turn requirements, in particular safety requirements, can be taken into account in the determination of the working position, so that in turn the risks mentioned at the beginning can likewise be reduced or eliminated.

It is also conceivable that the working position is determined on the basis of a construction-site data record. It may consequently be determined in particular on the basis of the structural-part data record and on the basis of the construction-site data record.

In order to counter any deviations in reality from BIM planning data, the working position may also be ascertained by a predefined target working position being modified, in particular by using the structural-part data record, the construction-site data record and/or the rule data record.

For such a target/actual comparison, the structural-part data record and/or the construction-site data record may be ascertained by means of a recording sensor of the power tool system, in particular the control unit.

The control unit may also be set up to control in addition to the working position at least one further parameter of the work of the mobile power tool on the basis of the structural-part data record, the construction-site data record and/or the control data record. This further parameter may be for example a type of tool, a tool dimension, a pressing force, a speed, for example an advancing rate, a torque or the like.

In some countries, ceiling elements are for example produced by filling a formwork, for example in the case of so-called composite concrete floors. The formwork may in particular comprise one or more profiled sheets. The profiled sheet or sheets may comprise at least one corrugated sheet, a trapezoidal sheet or some other sheet reinforced by geometrical structures. The at least one profiled sheet may be used as permanent formwork.

A surface of the structural part may be scanned, in particular optically. For example in the case of such profiled sheets, it has proven to be favorable if the surface of the structural part is scanned, in particular optically, in the form of a point and/or in the form of a line. This can make precise determination of the geometry or parts of the geometry possible. In particular, a comparison of the geometry determined with data of the structural part and/or data of a BIM model can also be performed.

For this purpose, the scanning may be performed by means of a scanning sensor. The scanning sensor may for example be a laser distance meter and/or comprise such a meter. A laser beam of the scanning sensor may be deflected in the form of a line, for example in the form of a loop. For this purpose, the laser beam may be diverted and/or the laser distance meter may be moved in a suitable way.

It is also conceivable that the distance sensor comprises a 2D and/or a 3D sensor. For this purpose, the scanning sensor may for example comprise an optical camera. It may also comprise a 3D camera.

At least one rule data record may then be used to conclude from the scanned surface a position and/or a location of the structural part, for example in relation to the construction site. Consequently, the working position can also be determined directly and/or indirectly.

Consequently, the working position on a structural part comprising the profiled sheet can be determined.

For scanning the surface, the scanning sensor may be movable in relation to the surface. For this purpose, the scanning sensor may for example be arranged on a manipulator, in particular on an end effector of the manipulator.

As well as the surface of the structural part, at least one supporting structure and/or installation elements may also be scanned, for example with respect to their respective three-dimensional structures. Such scanning may be performed by the same and/or identical means to the scanning of the surface.

A path for reaching the working position with the mobile power tool, in particular with its manipulator and/or a tool arranged on it, for example a drill or a setting tool, may be planned. The planning of the path may in this case take into account data obtained from the scanning. If for example the working position is in the direct vicinity of a detected object, for example the supporting structure, a sequence of movements of the manipulator may be planned and/or controlled in such a way that the manipulator moves past the detected object without bumping into it.

Further features and advantages of the invention emerge from the following detailed description of exemplary embodiments of the invention, with reference to the figures of the drawing, which shows details essential to the invention, and from the claims. The features shown there are not necessarily to be understood as true to scale and are shown in such a way that the special features according to the invention can be made clearly visible. The various features can be implemented individually in their own right or collectively in any combination in variants of the invention.

In the schematic drawing, exemplary embodiments of the invention are shown and explained in more detail in the following description.

In the figures:

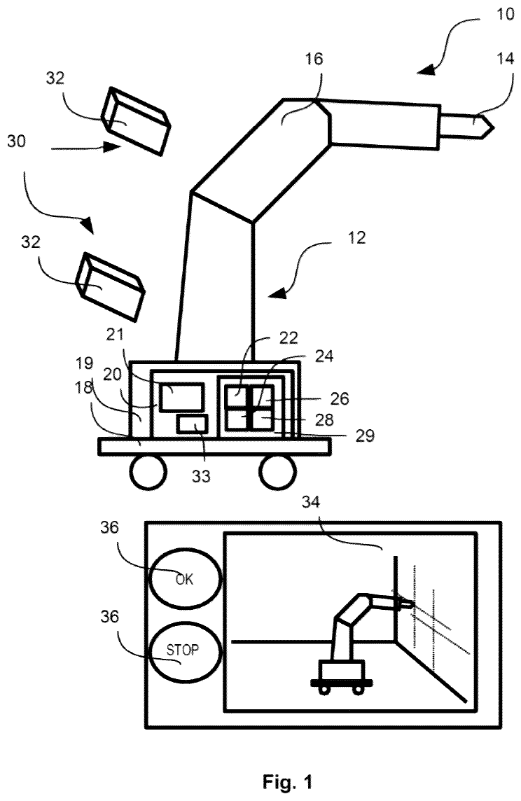

FIG. 1 shows a power tool system;

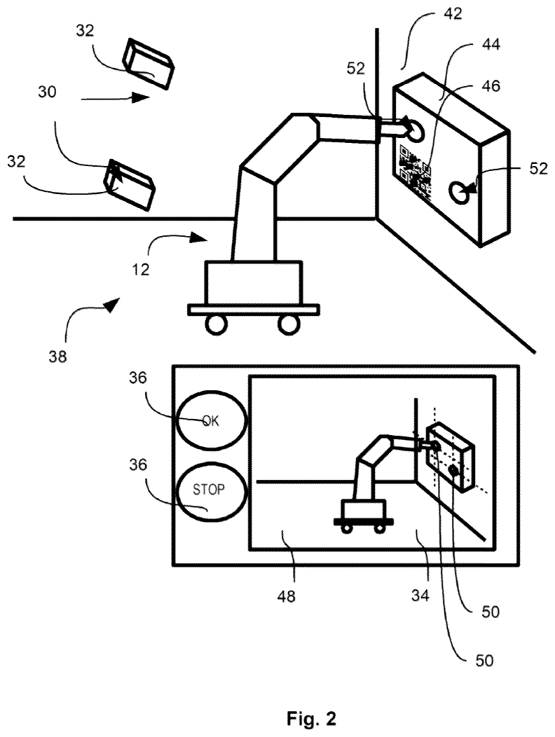

FIG. 2 shows a schematic representation of the power tool system in a first example of a determination of working positions;

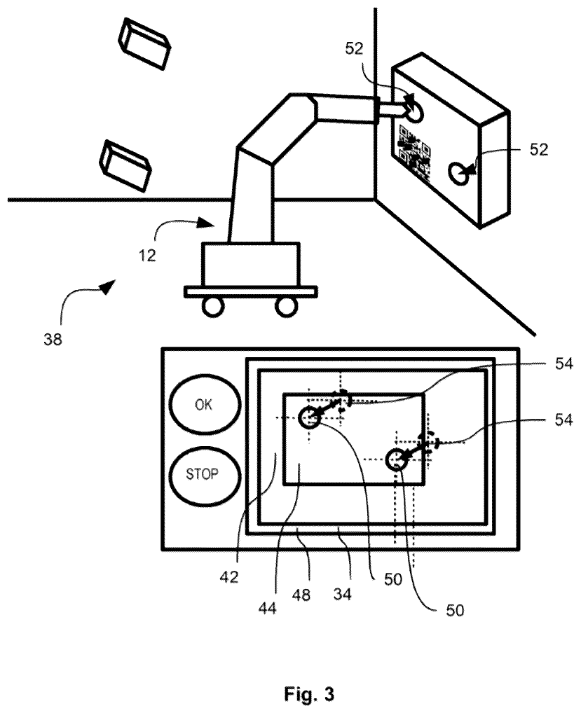

FIG. 3 shows a schematic representation of the power tool system in the case of a second example of a determination of working positions;

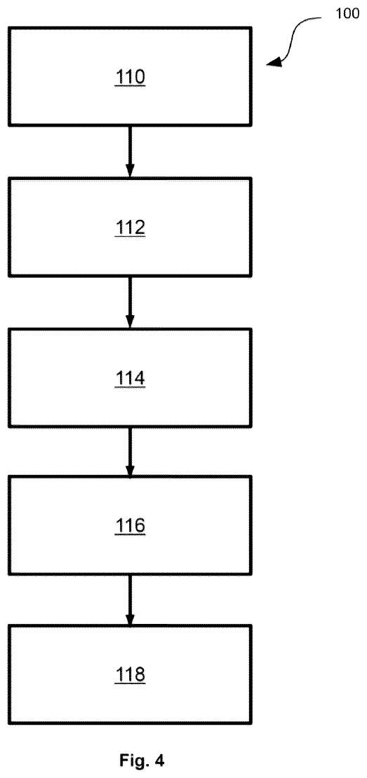

FIG. 4 shows a flow diagram of a method;

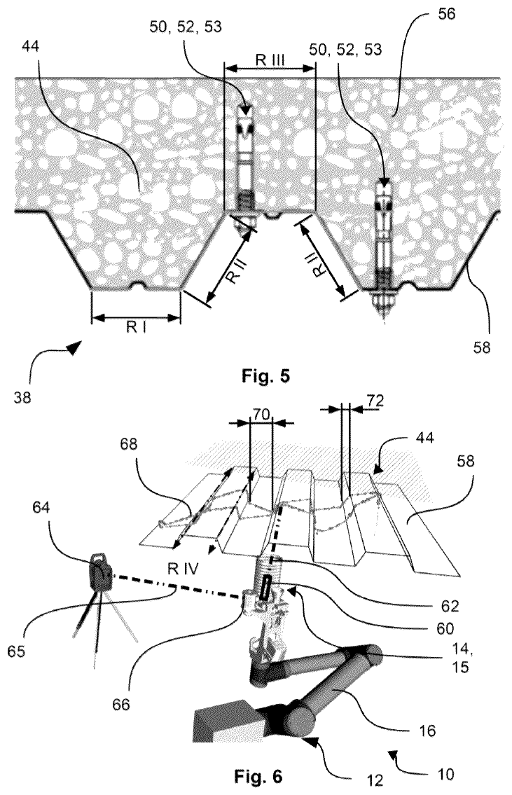

FIG. 5 shows a schematic sectional view through a structural part formed as a ceiling element; and

FIG. 6 shows the structural part according to FIG. 5 and a power tool system in a schematic, perspective representation.

In order to make it easier to understand the invention, the same reference signs are used in each case for identical or functionally corresponding elements in the following description of the figures.

FIG. 1 shows a schematic representation of a power tool system 10. The power tool system 10 has a mobile power tool 12, which is set up as a construction robot for use in building construction and civil engineering. In particular, the mobile power tool 12 is set up for working at at least one working position on a construction site; it is equipped with a drilling tool 14 and can consequently perform drilling work.

The drilling tool 14 is arranged on a multiaxis manipulator 16 of the mobile power tool 12. By means of an undercarriage 18, the mobile power tool 12 can move along on a construction site, preferably automatically or at least under remote control.

In a housing 19 of the undercarriage 18, a control unit 20 for controlling the mobile power tool 12 is accommodated. The control unit 20 is formed as a computer unit.

The control unit 20 comprises a microprocessor unit 21, a program-code storage unit 22, in which program code that can be executed on the microprocessor unit 21 can be stored, and also a structural-part data storage unit 24, in which at least one structural-part data record relating to at least one structural part to be used on the construction site can be stored.

The control unit 20 also has a construction-site data storage unit 26 for storing at least one construction-site data record and also a rule data storage unit 28, in which at least one rule data record can be stored. The storage units 22, 24, 26 and 28 are all realized together by an overall storage unit 29, for example a non-volatile, writable and readable storage unit.

The mobile power tool 12 also has a recording sensor 30. The recording sensor 30 is formed by two image-recording units 32, which together make it possible to record three-dimensional images of the surroundings. On the basis of the three-dimensional images, in particular lengths, for example distances, can be ascertained.

For the analysis of recorded images, an analysis unit 33 is formed in the control unit 20. For this purpose, the control unit 20 has a deep-learning unit.

The power tool system 10 also has a display unit 34, which is formed as part of the control unit 20, but independently of the rest of the control unit 20, in particular of a portable design. It can be used with the rest of the control unit 20 by way of a radio connection.

The display unit 34 is set up to show VR images. It also has two input buttons 36, with which the user of the power tool system 10 can acknowledge determined working positions, and can thereby start or prevent the performance of work.

FIG. 2 shows in a schematic representation determination of working positions by means of the previously described power tool system 10.

In the schematic representation according to FIG. 2 there can be seen a construction site 38, on which work is to be carried out on a structural part 44 on a wall 42. The structural part 44 may be for example a wall paneling element.

In the present example, two boreholes are to be made through the structural part 44 and into the wall 42.

The structural part 44 has a code 46, on the basis of which, and by means of the detection sensor 30, the control unit 20 detects the structural part 44.

By means of the code 46, the control unit 20 (see FIG. 1) retrieves structural-part data records in relation to the structural part 44 from the structural-part data storage unit 24 (likewise FIG. 1).

The structural-part data records may in particular comprise indications of positions at which boreholes are to be made. In addition, construction-site data records in relation to the construction site 38, in particular in relation to the wall 42, are recorded by way of the recording sensor 30.

The construction-site data records in this case comprise for example the position and the location of the wall 42 and also the relative position of the structural part 44 in relation to the wall 42.

By means of the structural-part data records and also the construction-site data records, working positions resulting from these data records are determined, in particular calculated.

The result is shown on the display unit 34 in the form of a VR image 48. In the VR image 48, firstly a depiction of the construction site 38 can be seen. In addition, working positions 50 are depicted—in the form of crosshairs—in the VR image 48. In addition to the crosshairs, the depicted working positions 50 comprise representations of the boreholes to be made.

If the user of the power tool system 10 then acknowledges the determined working positions 50 by one of the buttons 36, in particular the button 36 marked “OK”, the control unit 20 activates the mobile power tool 12 in such a way that it drills the desired boreholes at the determined working positions 50.

FIG. 2 specifically shows a situation in which the power tool system 10 has just completed the drilling work, so that two boreholes 52 have been drilled through the structural part 44 and into the wall 42.

FIG. 3 shows, likewise in a schematic representation, a further example of a determination of working positions.

As a difference from the situation according to FIG. 2, in the situation on which FIG. 3 is based there are target working positions from a BIM planning system. These target working positions are stored in the form of construction-site data records in the construction-site data storage unit 26 (see FIG. 1).

Unless otherwise described, the power tool system 10 corresponds to the previously described power tool system 10, this power tool system 10 having been modified in comparison with the previously described system to the extent that it can determine working positions on the basis of at least one preselected target working position.

It goes without saying that the power tool system 10 may be set up to determine working positions both with and without target working positions, depending on whether they are provided.

As can be seen in the representation according to FIG. 3, in this case the VR image 48 shows a schematic plan view of the wall 42 with the structural part 44. As an alternative or in addition, it is also conceivable that the power tool system 10 shows on the display unit 34 a VR image 48 in the manner of the previously described exemplary embodiment. Mixtures of the types of representation or other types of representation are also conceivable.

In a way corresponding to the position and location of the wall 42 recorded by the detection sensor 30, the resulting positions of the target working positions 54 are schematically shown within the VR image 48. It can be seen that the target working positions 54 are too close to peripheries of the structural part 44.

There are conflicts with structural-part data records for the structural part 44 that are stored in the structural-part data storage unit 24, in accordance with which the boreholes are to be made at certain minimum distances from the peripheries and also at certain maximum distances from the peripheries of the structural part 44.

The control unit 20 is therefore set up to provide an offset on the basis of the target working positions 54, by means of which the control unit 20 determines the final positions of the working positions 50. These determined working positions 50 are likewise depicted in the display unit 34.

After acknowledgement by the user, in turn the planned boreholes 52 are drilled at the positions corresponding to the determined working positions 50.

FIG. 4 shows a method 100 in the form of a flow diagram. To explain the method 100, the reference signs previously introduced are used once again below with reference to the power tool system 10 and with reference to the construction site 38.

In a first step 110, the power tool system 10, in particular the control unit 20, retrieves structural-part data records in relation to various structural parts that are stored in a cloud-based memory. Furthermore, construction-site data records from a BIM planning system are loaded into the construction-site data storage unit 26.

In a following step 112, a number of structural-part data records are recorded by means of the recording sensor 30 and the analysis unit 33. In particular, the type of the structural part 44 and also its position and location are ascertained. In addition, construction-site data records of the construction site 38 are recorded by means of the recording sensor 30 and the analysis unit 33. In particular, the position and the location of the wall 42 are ascertained.

In a further step 114, the working positions 50 are determined on the basis of the structural-part and construction-site data records. If there are target working positions 54, they are checked for conflicts on the basis of the structural-part data records and taking into account the construction-site data record.

If a conflict is found, the working position 50 respectively concerned is determined by determining a smallest required displacement of the target working position 54 to resolve the conflict concerned.

If there are rule data records, which can preferably be stored in the rule storage unit 28, the associated rules are additionally checked by the control unit 20.

For example, there may be a rule data record which provides an arrangement of the structural part 44 only at determined positions or in the form of a determined pattern within the construction site 38.

If this rule is not satisfied with the working position 50 determined at the time in question, the working position 50 is additionally modified, so that also all of the rules have been or are satisfied in a way corresponding to all of the rule data records concerned. If, as an exception, the entirety of the requirements to be taken into account according to the structural-part data records, the construction-site data records and the rule data records cannot be satisfied without conflict, it may be provided that the control unit 20 asks for interaction on the part of the user to decide on how to proceed.

In a further step 116, the determined working positions 50 and also possibly the target working positions 54 and also their displacement are shown on the display unit 34 as a VR image 48. Subsequently, the system waits for an acknowledgement by the user by means of the buttons 36.

Depending on the outcome of the acknowledgement by the user, then, in a final step 118, boreholes 52 are made, or generally work is performed, at the positions within the construction site 38 corresponding to the determined working positions 50, or performance of the work is blocked.

It goes without saying that the interactions in step 116 with the user, in particular what is shown on the display unit 34 and/or the obtainment of the acknowledgement, are optional.

In particular, it is possible to dispense with step 116 if the power tool system 10 is to be designed to act entirely autonomously, and in particular without interaction with the user, during the sequence of the method 100.

After completion of the work, it may be provided that the method is carried out once again, in particular beginning with step 110, until all of the working positions 50 where work is to be carried out have been determined and the corresponding work has been performed.

FIG. 5 shows a schematic sectional view of a structural part 44 on a construction site 38. The structural part 44 is formed as a ceiling element. It forms a ceiling of a building that is not shown any further in FIG. 5. The structural part 44 has a concrete layer 56. On the underside of the concrete layer 56 there is a profiled sheet 58, in particular a trapezoidal sheet. The profiled sheet 58 may have elevations, depressions and/or other geometries.

For producing the structural part 44, the profiled sheet 58 acts as permanent formwork for the concrete layer 56 produced by casting. In this way a composite concrete ceiling can be formed.

For setting anchors 53, boreholes 52 are to be drilled at working positions 50, preferably while maintaining a required minimum distance and/or a defined drilling position.

By way of example, FIG. 5 respectively shows two of such working positions 50, boreholes 52 and anchors 53.

Furthermore, various markings, for example color markings or codings, for example for subsequent building work, or for indications for later installation, are to be applied to the profiled sheet 58.

As a result of the trapezoidal cross section of the profiled sheet 58, the working positions 50, and consequently the positions of the boreholes 52 and the anchors 58, are subject to characteristics specific to the structural part. These characteristics are depicted by way of example by structural-part data records R I, R II, R III.

For example, the structural-part data records R I and R III correspond to the characteristic that, in portions of the profiled sheet 58 that run horizontally, or at least substantially horizontally, both working positions 50 for boreholes 52 are available and color markings can be marked in these portions.

A further characteristic may be that, for example in portions of the profiled sheet 58 that run obliquely to the horizontal, by contrast, only markings are to be applied, but boreholes 52 are not to be drilled. This characteristic of the structural part 44 corresponds to structural-part data records R II shown by way of example in FIG. 5.

FIG. 6 shows a structural part 44 according to FIG. 5 and also a power tool system 10 in a schematic perspective representation.

To simplify the representation and the further explanations, in FIG. 6 the concrete layer 56 is only schematically depicted by a hatched area. Likewise for representational reasons, in FIG. 6 the profiled sheet 58 is depicted partly transparently as a line representation. The profiled sheet 58 is only given by way of example and may also have a different geometry than the geometry depicted in FIG. 6.

Unless described otherwise below, the power tool system 10 may correspond to the previously described power tool system 10. In particular, it has a mobile power tool 12. Furthermore, it has the manipulator 16 with a drilling tool 14, in particular within a dust extraction system 15.

In the region of the dust extraction system 15 there is also a distance meter 60. The distance meter 60 is formed as a laser distance meter. It is designed to scan, in particular optically, a surface, in particular the underside, of the profiled sheet 58 by means of a laser beam 62. It is set up in particular to determine in each case its distance from a point of impingement of the laser beam 62 on the profiled sheet 58. This may take place for example by one or more time-of-flight measurements.

The position and location of the distance meter 60, and consequently of the drilling tool 40 arranged rigidly in relation to it, takes place by means of a position measuring device. In this exemplary embodiment, the position measuring device has a fully automatic total station 64, which with its own laser beam 65 tracks a reflector 66. In the case of alternative embodiments, other position measuring devices are also conceivable. For example, a position measurement may also take place by measuring the positions and/or locations of individual arm elements of the manipulator 16.

The profiled sheet 58 is formed by a multiplicity of folded metal-sheet elements, which are arranged in relation to one another in such a way that channels required for the trapezoidal cross section are formed with depressions, slopes or elevations. The channels respectively run parallel to one another. This characteristic is schematically shown in FIG. 6 by a rule data record IV.

By means of the rule data record IV, working positions 50 (FIG. 5) can be determined on the profiled sheet 58. Firstly, portions running horizontally thereto and also possibly portions running obliquely with respect to the horizontal of the profiled sheet 58 are to be located in order to be able to use the structural-part data records R I, R II and/or R III (FIG. 5) or possibly further structural-part data records for further determination of the working positions 50.

For this purpose, firstly the underside of the profiled sheet 58 is scanned in the form of a line, for example along a scanning path 68 in the form of a loop. In particular, a height profile of the profiled sheet 58 is measured along the scanning path 68 by means of the distance meter 60.

For scanning along the scanning path 68, the distance meter 60 is moved by means of the manipulator 16, preferably in a horizontal plane. The course of the positions of the distance meter 60, and consequently of the laser beam 62 or its points of impingement, along the scanning path 68, are logged by the total station 64 in combination with the concomitantly moved reflector 66. The scanning may take place at a scanning rate of for example at least 10 Hz, preferably of at least 20 Hz.

Contiguous sections of the scanning path 68 with constant, or at least only slightly varying, distances, in FIG. 6 for example the section 70, may indicate horizontal portions of the profiled sheet 58. Contiguous sections of the scanning path 68 with increasing or decreasing distances, in FIG. 6 for example section 72, may by contrast indicate portions running obliquely to the horizontal of the profiled sheet 58.

Since it is known by means of the rule data record IV that the horizontal or oblique portions respectively run in a straight line and parallel to one another, the positions and/or locations of the horizontal and oblique portions of the profiled sheet 58 are extrapolated from the respective contiguous sections, that is to say for example the sections 70 or 72, to the entire profiled sheet 58.

This produces the positions and/or locations of the horizontal portions and, to the extent required, for example in the case where markings are to be set, of the portions running obliquely to the horizontal of the profiled sheet.

Consequently, the structural-part data records R I, R II and/or R III and/or possibly further structural-part data records with reference to the structural part 44 can thus be used for the fine determination of working positions 50. In particular, as a result it can consequently be ensured that for example boreholes 52 are only drilled in horizontally running portions of the profiled sheet 58. This can consequently be ensured even whenever the position and/or the location of the profiled sheet 58 in relation to the construction site 38 deviate(s) from a planned position and/or a planned location.

Disturbing influences of reflections of the surface of the profiled sheet 58 can be minimized by the scanning of the profiled sheet 58 in the form of a point or in the form of a line. Since the scanning path 68 only needs to cover a partial region of the profiled sheet 58, the time expenditure for the measurements of the position and/or location of the profiled element 58 is also reduced.

It is also conceivable that, in the previously described way, a target working position is modified, for example in a way corresponding to planning in a BIM model, while taking into account the rule data record R IV and/or further rule data records and also the structural-part data records R I, R II, R III and/or further structural-part data records, and in particular for the case where the structural part 44 has one or more profiled sheets.

A rule data record and/or a structural-part data record may also comprise a limitation of any changing of the working position 50. For example, it may be provided that a working position, for example a drilling position, can only be changed at most up to a maximum permissible distance.

At least one accuracy criterion may also be taken into account when changing the working position.

### LIST OF REFERENCE SIGNS

10 Power tool system
12 Mobile power tool
14 Drilling tool
15 Dust extraction system
16 Manipulator
18 Undercarriage
19 Housing
20 Control unit
21 Microprocessor unit
22 Program-code storage unit
24 Structural-part data storage unit
26 Construction-site data storage unit
28 Rule data storage unit
29 Overall storage unit
30 Recording sensor
32 Image-recording unit
33 Analysis unit
34 Display unit
36 Input button
38 Construction site
42 Wall
44 Structural part
46 Code
48 Image
50 Working position
52 Borehole
53 Anchor
54 Target working position
56 Concrete layer
58 Profiled sheet
60 Distance meter
62 Laser beam
64 Total station
66 Reflector
68 Scanning path
70 Section
72 Section
R I, R II, R III Structural-part data record
R IV Rule data record
100 Method
110 Step
112 Step
114 Step
116 Step
118 Step

1. A power tool system for a construction site, comprising
a mobile power tool,
the mobile power tool being set up for working at at least one working position on the construction site,
a control unit for controlling the mobile power tool, comprising a microprocessor unit and a program-code storage unit, in which program code that can be executed on the microprocessor unit can be stored, and also a structural-part data storage unit, in which at least one structural-part data record relating to at least one structural part to be used on the construction site can be stored, the control unit being set up to determine the working position on the basis of a structural-part data record stored in the structural-part data storage unit.

2. The power tool system as claimed claim 1, wherein the control unit is set up to determine the working position by using a construction-site data record of a construction-site data storage unit.

3. The power tool system as claimed in claim 1, wherein the control unit is set up to determine the working position by using a rule data record of a rule data storage unit.

4. The power tool system as claimed in claim 1, wherein the control unit has a recording sensor for recording at least one structural-part data record and/or a construction-site data record.

5. The power tool system as claimed in claim 1, wherein the recording sensor comprises an image-recording unit for recording a one-dimensional, two-dimensional and/or three-dimensional image.

6. The power tool system as claimed in claim 1, wherein the control unit comprises an analysis unit for analysis of the image.

7. The power tool system as claimed in claim 1, wherein the mobile power tool is set up for drilling, hammer-drilling and/or chiseling.

8. The power tool system as claimed in claim 1, wherein the mobile power tool is set up to select the tool to be used for performing the work from a set of tools.

9. The power tool system as claimed in claim 1, wherein at least one element of the power tool system can be operated without a cable.

10. The power tool system as claimed in claim 1, wherein the control unit has a display unit.

11. A method for controlling a mobile power tool the mobile power tool being set up for working at at least one working position of the construction site, the method including determining the at least one working position on a basis of a structural-part data record.

12. The method as claimed in claim 11, including determining the at least one working position on a basis of a construction-site data record.

13. The method as claimed in claim 11, including ascertaining the at least one working position by a predefined target working position being modified.

14. The method as claimed in claim 11, including ascertaining the structural-part data record and/or a construction-site data record by a recording sensor of the power tool system.

15. The method as claimed in claim 11, including determining the at least one working position on a structural part comprising a profiled sheet.

16. The method as claimed in claim 11, including scanning a surface of a structural part.

17. The method as claimed in claim 11, including scanning the surface of a structural part.

18. The power tool system of claim 1, wherein the mobile power tool is set up for working with a tool at the at least one working position on the construction site.

19. The power tool system of claim 9, wherein the mobile power tool or the control unit or at least part of the control unit can be operated without a cable.

20. The power tool system of claim 10, wherein the display unit is for showing an Augmented Reality Image.
